(19) United States
(12) Patent Application Publication
(10) Pub. No.: US 2006/0196304 A1
(43) Pub. Date: Sep. 7, 2006

(54) Inverted oil pan mounting for mono-block housings

(76) Inventor: Michael E. Konruff, Burlington, WI (US)

Correspondence Address: QUARLES & BRADY LLP, 411 E. WISCONSIN AVENUE, SUITE 2040, MILWAUKEE, WI, 53202-4497, US

(21) Appl. No.: 11/063,155

(22) Filed: Feb. 22, 2005

(51) Int. Cl. F16H 57/02

(52) U.S. Cl. 74/606 R

(57) ABSTRACT

A gear drive with a mono-block gear housing with a bottom aperture through which mounts a specially designed oil exclusion pan and bearing oil dams, over which a bottom-mounted access cover seals the housing in normal operation.

### FIELD OF THE INVENTION

The invention relates to gear drive assemblies that have mono-block housings, and more particularly to lubrication systems for gear drive assemblies that have such mono-block housings.

### BACKGROUND OF THE INVENTION

Industrial gear drives have become more torque dense with material advances and new heat-treating methods of manufacture. That is more torque can be transmitted through a physically smaller gear drive. A problem with a physically smaller drive is that it does not have a large enough surface area to dissipate all of the heat generated by the drive. The thermal rating of the drive thus becomes less than the mechanical rating of the drive. Therefore, the gear drive cannot operate at its full mechanical capacity. A contributing factor to the generation of heat in gear drives that have low gear ratios is that there are two large revolving elements that rotate at relatively high speeds. This causes more oil to churn and it results in even higher heat generation. This problem is amplified in single reduction drives.

One way to combat excessive heat generation is to lower the oil level so that the gears cause less churning of the oil. Lowering the oil level may not be adequate to reduce heat generation sufficiently and it may not even be possible to lower the oil level in a drive, since all revolving elements in the drive, such as the gears and bearings, need to dip in oil, be pressure lubricated or receive splash lubrication. Adding oil dams at bearing locations to keep oil in the bearings may accommodate lower oil levels. In a drive that has a two-piece housing, an oil exclusion pan many be used to keep oil away from the largest geared element that is churning the most oil. The oil exclusion pan mounts inside the drive along the bottom of the drive housing and it baffles the portion of the low-speed gear that would normally be immersed in oil. Small holes in the pan allow a limited amount of oil to be exposed to the gear for lubrication purposes.

A gear drive with single piece or mono-block housings makes installation of such oil dams and an oil exclusion pan difficult. Assembly of a gear drive that has a mono-block housing requires installation of the gears, bearings, spacers and so forth onto their respective shafts within the housing. In a split or two-piece housing, each shaft may be installed in one piece of the housing after all components are assembled on the shaft and then the other piece of the housing fastens to the piece in which the shafts are installed. In a gear drive with a mono-block housing, it is impossible to install bearing oil dams and an oil pan in the bottom of the housing before assembling the shafting. Likewise, it is impossible to install an oil pan in the bottom of the housing after the gears and shafts have been assembled in the housing.

### SUMMARY OF THE INVENTION

The invention comprises a gear drive with a mono-block gear housing that has an aperture in its bottom for a bottom-mounted access cover. With the housing inverted, a specially designed oil exclusion pan and bearing oil dams mount to the housing through the bottom aperture. The bottom-mounted access cover then attaches to the housing. With the housing turned upright, the standard inspection cover mounts to the housing and the housing may be installed in a normal manner.

In a preferred embodiment, the invention comprises a gear drive with a mono-block housing, comprising: an access aperture in a bottom of the housing; an oil exclusion pan mounted through the access aperture for covering at least one gear within the housing; and an access cover for sealing the access aperture after the oil exclusion pan and oil dams are mounted in the housing.

### DESCRIPTION OF THE DRAWINGS

FIG. 1 is an exploded inverted isometric view of a gear drive with a mono-block housing according to the invention.

FIG. 2 is an upright cut-away isometric view of a gear drive with a mono-block housing according to the invention that shows detail of the oil pan installation.

FIG. 3 is another cut-away isometric view of a gear drive with a mono-block housing according to the invention that shows detail of the oil dam installation.

### DETAILED DESCRIPTION OF THE INVENTION

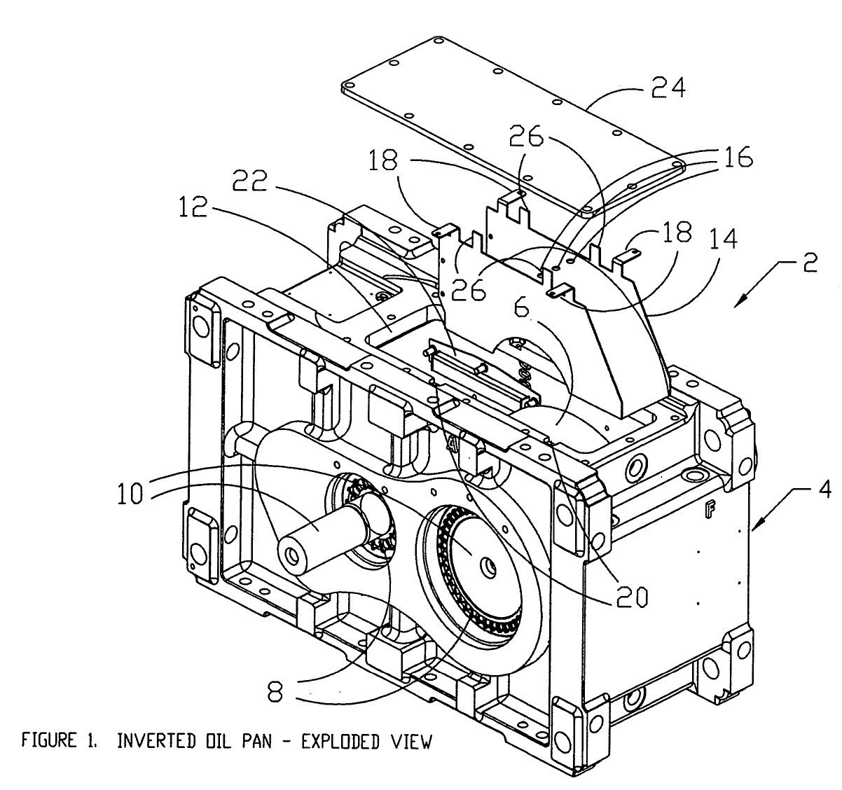

FIG. 1 is an exploded inverted isometric view of a gear drive 2 with a mono-block housing 4 according to the invention. With the housing 4 inverted as shown, a low-speed gear 6 a mating high-speed pinion (not shown) and associated bearings 8 are assembled on their respective shafts 10 within the housing 4 through a special access aperture 12 in the bottom of the housing 4. A special oil exclusion pan 14 is then inserted through the aperture 12 in an inverted orientation to cover the large low-speed gear 6 in the drive 2.

The pan 14 has conventional oil flow apertures 16 to allow a limited quantity of oil to flow through the pan 14 in order to lubricate the large low-speed gear 6. The pan 14 also has a plurality of special alignment tabs 18 that fit within a corresponding plurality of recesses 20 that are arranged around the perimeter of the access aperture 12 to correctly position the pan 14 over the large low-speed gear 6. Oil dams 22, for creating oil reservoirs for the bearings 8, may be inserted in an inverted position through the access aperture 12 to mount between the bearings 8 and the pan 14. A bottom access cover 24 then mounts over the access aperture 12 to seal the housing 4. The pan 14 has a plurality of special support legs 26 that protrude from the pan 14 to rest against the bottom access cover 24 for additional support and accurate vertical positioning in relation to the large low-speed gear 6.

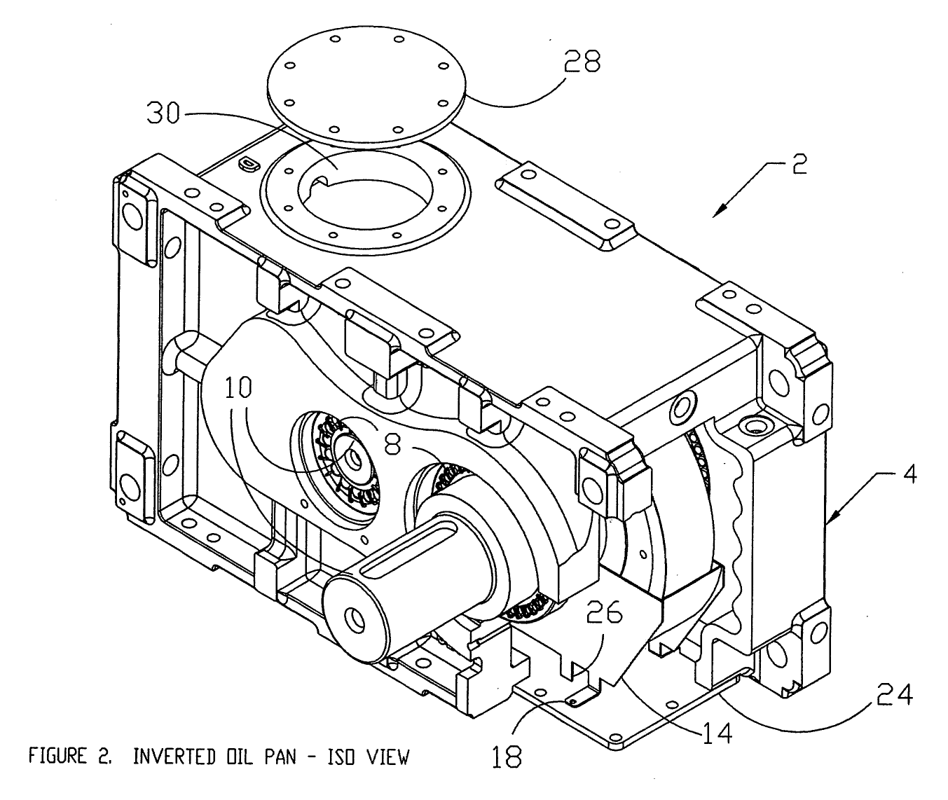

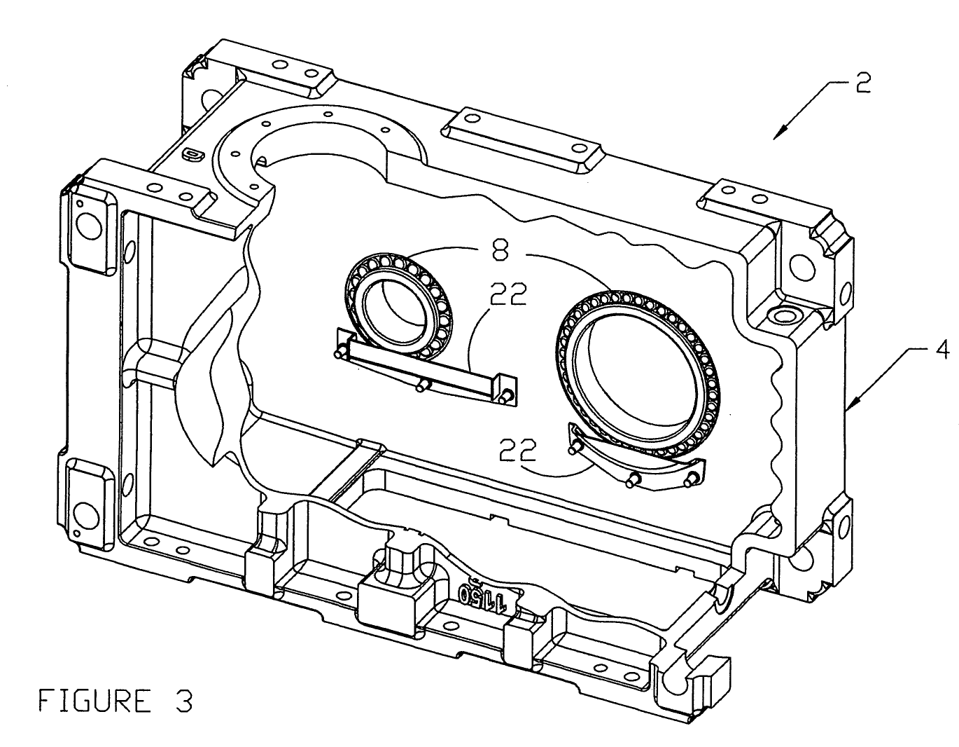

A shown in FIG. 2, the gear drive 2 is then turned upright to complete assembly. An inspection cover 28 fits into a corresponding inspection aperture 30 in the top of the housing 4 for ordinary inspection purposes. In the upright position, the pan 14 is correctly position below the large low-speed gears 6 to limit the amount of oil that contacts the low-speed gear 6 in order to reduce churning losses and increase thermal rating of the gear drive 2. The oil dams 22 are also correctly positioned to retain oil at the bearings 8, as shown in FIG. 3.

As shown in FIG. 3, some of the oil dams 22 may be elongated to be compatible with a plurality of different centre distances; that is, the distance between the axes of the shafts 10 of the mating high-speed pinion and low-speed gear 6. Furthermore, the oil exclusion pan 14 may be elongated to cover both the high-speed pinion and low-speed gear 6 to further reduce oil churning and improve thermal capacity.

Described above is a gear drive with a mono-block gear housing with a bottom aperture through which mounts a specially designed oil exclusion pan and bearing oil dams, over which a bottom-mounted access cover seals the housing in normal operation. It should be understood that this embodiment is only an illustrative implementation of the invention, that the various parts and arrangement thereof may be changed or substituted, and that the invention is only limited by the scope of the attached claims.

What is claimed is:

1. A gear drive with a mono-block housing, comprising:
an access aperture in a bottom of the housing;
an oil exclusion pan mounted through the access aperture for covering at least one gear within the housing; and
an access cover for sealing the access aperture after the oil exclusion pan is mounted in the housing.

2. The gear drive of claim 1, wherein the access aperture has a plurality of recesses arranged around its perimeter and the oil exclusion pan has a plurality of corresponding alignment tabs that engage the recesses for to correctly position the oil exclusion pan over each covered gear.

3. The gear drive of claim 1, wherein the oil exclusion pan has a plurality of support legs to rest against the access cover for additional support and accurate vertical positioning of the oil exclusion pan in relation to each covered gear.

4. The gear drive of claim 1, wherein the oil exclusion pan covers a low-speed gear within the gear drive.

5. The gear drive of claim 1, wherein the oil exclusion pan covers both a low-speed gear and a mating high-speed pinion within the gear drive.

6. The gear drive of claim 1, further comprising oil dams mounted through the access aperture for retaining oil for bearings adjacent to the oil exclusion pan.

7. The gear drive of claim 6, wherein the oil dams are elongated to be compatible with a plurality of different centre distances.

8. A gear drive with a mono-block housing, comprising:
an access aperture in a bottom of the housing that has a plurality of recesses arranged around its perimeter;
an oil exclusion pan mounted through the access aperture for covering at least one gear within the housing that has a plurality of alignment tabs that engage the recesses to correctly position the oil exclusion pan over each covered gear and a plurality of support legs; and
an access cover for sealing the access aperture after the oil exclusion pan is mounted in the housing that rests against the oil exclusion pan support legs for additional support and accurate vertical positioning of the oil exclusion pan in relation to each covered gear.

9. The gear drive of claim 8, wherein the oil exclusion pan covers a low-speed gear within the gear drive.

10. The gear drive of claim 8, wherein the oil exclusion pan covers both a low-speed gear and a mating high-speed pinion within the gear drive.

11. The gear drive of claim 8, further comprising oil dams mounted through the access aperture for retaining oil for bearings adjacent to the oil exclusion pan

12. The gear drive of claim 11, wherein the oil dams are elongated to be compatible with a plurality of different centre distances.

13. A gear drive with a mono-block housing, comprising:
an access aperture in a bottom of the housing that has a plurality of recesses arranged around its perimeter;
an oil exclusion pan mounted through the access aperture for covering a low-speed gear within the housing that has a plurality of alignment tabs that engage the recesses to correctly position the oil exclusion pan over the low-speed gear and a plurality of support legs;
oil dams mounted through the access aperture for retaining oil for bearings adjacent to the oil exclusion pan; and
an access cover for sealing the access aperture after the oil exclusion pan and oil dams are mounted in the housing that rests against the oil exclusion pan support legs for additional support and accurate vertical positioning of the oil exclusion pan in relation to the low-speed gear.

14. The gear drive of claim 13, wherein the oil exclusion pan covers both the low-speed gear and a mating high-speed pinion within the gear drive.

15. The gear drive of claim 13, wherein the oil dams are elongated to be compatible with a plurality of different centre distances.
